(19) United States
(12) Patent Application Publication
(10) Pub. No.: US 2025/0337290 A1
(43) Pub. Date: Oct. 30, 2025

(54) ROTATING ELECTRICAL MACHINE

(71) Applicant: NIDEC CORPORATION, Kyoto (JP)

(72) Inventors: Yusuke ARAO, Kyoto (JP); Shota KAWASHIMA, Kyoto (JP)

(21) Appl. No.: 19/189,548

(22) Filed: Apr. 25, 2025

(30) Foreign Application Priority Data
Apr. 26, 2024 (JP) 2024-072143

(51) Int. Cl. H02K 1/14; H02K 1/278

(52) U.S. Cl. CPC H02K 1/14; H02K 1/278

(57) ABSTRACT

A rotating electrical machine includes a rotor and a stator. The rotor includes a shaft, a rotor core, magnets arranged on a radially outer surface of the rotor core, and magnetic portions provided on the radially outer surfaces of the magnets and each including an outer peripheral surface that is a curved surface. The stator core of the stator includes an annular core back portion and tooth portions arranged along the inner peripheral surface of the core back portion. The tooth portions each includes a tooth body portion extending radially inward from an inner peripheral surface of the core back portion, and an umbrella portion protruding to two sides in the circumferential direction at a distal end portion of the tooth body portion. A groove portion extending along the axial direction is provided on a surface facing radially inward of the tooth portion.

### CROSS-REFERENCE TO RELATED APPLICATIONS

The present application claims priority under 35 U.S.C. § 119 to Japanese Patent Application No. 2024-072143, filed on Apr. 26, 2024, the entire contents of which are hereby incorporated herein by reference.

### FIELD OF THE INVENTION

The present disclosure relates to rotating electrical machines.

### BACKGROUND

In a motor having a rotor and a stator, in order to suppress vibration and noise during driving, a configuration is disclosed in which grooves are provided in shoes disposed on both sides of a distal end of a body of a stator core to suppress cogging torque.

In the motor as described above, when the curvature of the outer peripheral surface of the rotor facing the stator is small, the magnetic flux density entering the stator from the rotor tends to change rapidly during rotation of the rotor, and thus it may be difficult to suppress the cogging torque.

### SUMMARY

One example embodiment of a rotating electrical machine of the present disclosure includes a rotor rotatable about a central axis, and a stator located radially outside the rotor. The rotor includes a shaft extending in an axial direction about the central axis, a rotor core fixed to the shaft, a plurality of magnets arranged in the circumferential direction on the radially outer surface of the rotor core, and a magnetic portion on the radially outer surface of each of the plurality of magnets and including an outer peripheral surface that is a curved surface. The stator includes a stator core radially opposing the rotor with a gap interposed therebetween. The stator core includes a core back portion having an annular shape centered on the central axis, and a plurality of tooth portions arranged along the inner peripheral surface of the core back portion. Each of the tooth portions includes a tooth body portion extending radially inward from the inner peripheral surface of the core back portion, and an umbrella portion protruding to two sides in the circumferential direction at a distal end portion of the tooth body portion. A groove portion extending along the axial direction is provided on a surface facing radially inward of the tooth portion.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a schematic cross-sectional view illustrating a rotating electrical machine according to an example embodiment of the present disclosure.

FIG. 2 is a perspective view illustrating a portion of a rotor of an example embodiment of the present disclosure.

FIG. 3 is a cross-sectional view taken along line III-III of FIG. 1 illustrating the rotating electrical machine of an example embodiment of the present disclosure.

FIG. 4 is a cross-sectional view illustrating a portion of a stator core according to an example embodiment of the present disclosure.

FIG. 5 is a diagram illustrating a relationship between a groove width ratio, cogging torque, and motor torque according to an example embodiment of the present disclosure.

FIG. 6 is a cross-sectional view illustrating a portion of a stator core according to a modification of an example embodiment of the present disclosure.

### DETAILED DESCRIPTION

The drawings each illustrate a Z-axis appropriately in the description below. The Z-axis is a direction in which a central axis J of a rotor of an example embodiment described below extends. The central axis J illustrated in each drawing is a virtual axis. In the below description, a direction in which the central axis J extends, or a direction parallel to the Z-axis, is referred to as an “axial direction”. A radial direction about the central axis J is simply referred to as a “radial direction”. A circumferential direction about the central axis J is simply referred to as a “circumferential direction”. Of the axial direction, a side where the arrow of the Z-axis is directed (+Z side) is referred to as an “upper side”. Of the axial direction, a side opposite to the side where the arrow of the Z-axis is directed (−Z side) is referred to as a “lower side”. The upper side and the lower side are simply terms for describing a relative positional relationship of components, and thus an actual placement relationship and the like may be other than the placement relationship and the like indicated by these terms.

The circumferential direction is indicated by an arrow θ in each drawing. Of the circumferential direction, a side where the arrow θ faces is referred to as “one side in the circumferential direction”. Of the circumferential direction, a side opposite to the side where the arrow θ faces is referred to as “the other side in the circumferential direction”. The one side in the circumferential direction is a side proceeding clockwise around the central axis J (+θ side) when viewed from the upper side (+Z side). The other side in the circumferential direction is a side proceeding counterclockwise around the central axis J (−θ side) when viewed from the upper side.

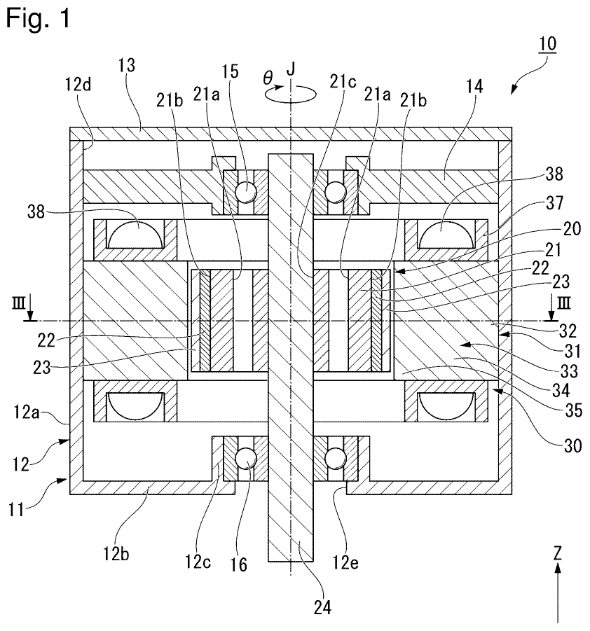

A rotating electrical machine 10 of the present example embodiment illustrated in FIG. 1 is a motor to be attached to a device or the like mounted on a vehicle. The device to which the rotating electrical machine 10 is attached may be an automatic transmission or a drive device that drives an axle of a vehicle. The rotating electrical machine 10 includes a housing 11, a rotor 20, a stator 30, a first bearing 15, and a second bearing 16.

The housing 11 accommodates the rotor 20, the stator 30, the first bearing 15, and the second bearing 16 therein. The housing 11 includes a cylindrical portion 12, an upper cover portion 13, and a first bearing holding portion 14. The cylindrical portion 12 has a cylindrical shape extending in the axial direction with the central axis J as the center.

The cylindrical portion 12 opens upward. The cylindrical portion 12 includes a side wall portion 12a, a lower wall portion 12b, and a second bearing holding portion 12c.

The side wall portion 12a has a cylindrical shape extending in the axial direction with the central axis J as the center. The side wall portion 12a surrounds the rotor 20, the stator 30, the first bearing 15, and the second bearing 16 from radially outside. The upper end of the side wall portion 12a is the upper end of the cylindrical portion 12. An opening 12d that opens upward is provided at the upper end of the side wall portion 12a.

The lower wall portion 12b has an annular plate shape centered on the central axis J. The plate surface of the lower wall portion 12b faces the axial direction. The radially outer end of the lower wall portion 12b is connected to the lower end of the side wall portion 12a. The lower wall portion 12b is provided with a lower wall hole 12e axially penetrating the lower wall portion 12b. When viewed from the axial direction, the lower wall hole 12e has a circular shape centered on the central axis J.

The second bearing holding portion 12c protrudes upward from the lower wall portion 12b. The second bearing holding portion 12c has a cylindrical shape centered on the central axis J. The second bearing holding portion 12c opens upward. The inner diameter of the second bearing holding portion 12c is larger than the inner diameter of the lower wall hole 12e. The second bearing 16 is held on the inner peripheral surface of the second bearing holding portion 12c.

The upper cover portion 13 has a disk shape centered on the central axis J. The plate surface of the upper cover portion 13 faces the axial direction. The upper cover portion 13 is fixed to the upper end of the cylindrical portion 12. The upper cover portion 13 closes the opening 12d from above.

The first bearing holding portion 14 is fixed to a portion of the inner peripheral surface of the side wall portion 12a above the rotor 20 and the stator 30. The first bearing holding portion 14 has a substantially annular shape centered on the central axis J. The first bearing 15 is held on the inner peripheral surface of the first bearing holding portion 14.

The rotor 20 is rotatable about the central axis J. The rotor 20 includes a rotor core 21, a plurality of magnets 22, a plurality of magnetic portions 23, and a shaft 24.

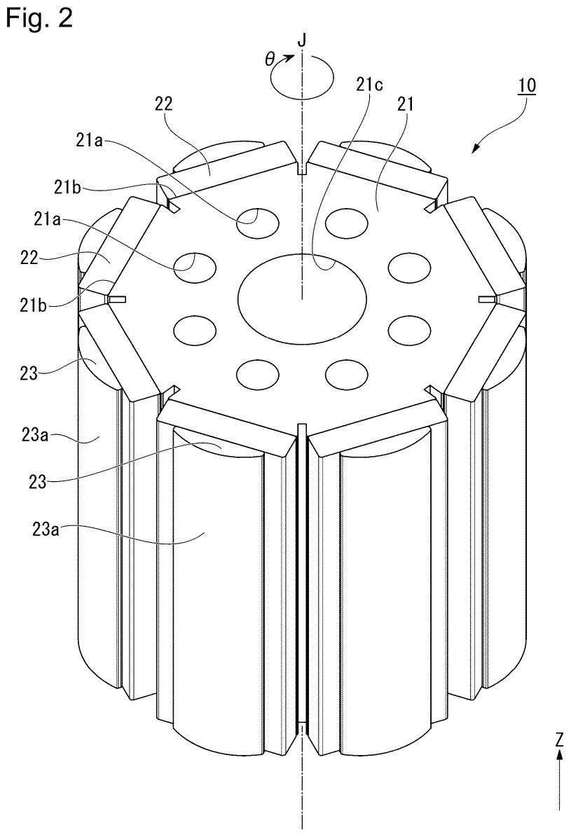

The rotor core 21 has a tubular shape extending in the axial direction about the central axis J. The rotor core 21 surrounds the shaft 24 from the radially outer side. The rotor core 21 has magnetism. For example, the rotor core 21 is a laminated steel sheet formed by laminating plurality of electromagnetic steel sheets in the axial direction. As illustrated in FIG. 2, the rotor core 21 has a polygonal shape when viewed from the axial direction. In the present example embodiment, the rotor core 21 has a substantially octagonal shape when viewed from the axial direction. The rotor core 21 includes a plurality of holes 21a, a plurality of flat surfaces 21b, and a through hole 21c.

As illustrated in FIG. 1, each of the plurality of holes 21a is a hole penetrating the rotor core 21 in the axial direction. As illustrated in FIG. 2, each hole 21a has a substantially circular shape when viewed from the axial direction. The holes 21a are spaced apart from each other along the circumferential direction. The holes 21a are disposed to surround the central axis J. In the present example embodiment, the rotor core 21 has eight holes 21a. By providing the plurality of holes 21a in the rotor core 21, it is possible to reduce the weight of the rotor core 21 and the material cost.

The plurality of flat surfaces 21b are radially outer surfaces of the rotor core 21. The flat surfaces 21b are arranged at intervals along the circumferential direction. In the present example embodiment, the rotor core 21 has eight flat surfaces 21b. Each flat surface 21b has a flat surface shape extending in a direction orthogonal to the radial direction. Each flat surface 21b extends in the axial direction over the entire axial length of the rotor core 21. In the present example embodiment, the axial length of the flat surface 21b is longer than the circumferential length.

As illustrated in FIG. 1, the through hole 21c is a hole that penetrates the rotor core 21 in the axial direction. When viewed from the axial direction, the through hole 21c has a circular shape centered on the central axis J. The shaft 24 is inserted into the through hole 21c. The shaft 24 is fixed to the inner peripheral surface of the through hole 21c.

As a result, the rotor core 21 is fixed to the shaft 24.

As illustrated in FIG. 2, each of the plurality of magnets 22 is provided on the flat surface 21b. That is, each of the plurality of magnets 22 is provided on the radially outer surface of the rotor core 21. In the present example embodiment, each magnet 22 is fixed to the flat surface 21b. Each magnet 22 has a plate shape extending in the axial direction. The plate surface of each magnet 22 faces the radial direction. In the axial direction, the upper end of each magnet 22 is disposed at the same position as the upper end of the rotor core 21. In the axial direction, the lower end of each magnet 22 is disposed at the same position as the lower end of the rotor core 21. The magnets 22 are arranged at intervals in the circumferential direction. In the present example embodiment, the rotor 20 includes eight magnets 22. In the present example embodiment, the number of poles of the rotor 20 is 8. The magnetic pole facing the radial outside of one magnet 22 is a magnetic pole different from the magnetic pole facing the radial outside of another magnet 22 arranged adjacent to the one magnet 22 in the circumferential direction.

As illustrated in FIG. 1, each of the plurality of magnetic portions 23 is provided on the radially outer surface of the magnet 22. Each magnetic portion 23 is fixed to the radially outer surface of the magnet 22. Each magnetic portion 23 faces the stator 30 in the radial direction with a space therebetween. As illustrated in FIG. 2, each magnetic portion 23 has a columnar shape extending in the axial direction. When viewed from the axial direction, each magnetic portion 23 has a substantially semicircular shape protruding radially outward. In the axial direction, the upper end of each magnetic portion 23 is disposed at the same position as the upper end of the rotor core 21. In the axial direction, the lower end of each magnetic portion 23 is disposed at the same position as the lower end of the rotor core 21. The magnetic portions 23 are disposed at intervals in the circumferential direction.

In the present example embodiment, the rotor 20 includes eight magnetic portions 23. In the present example embodiment, the magnetic portion 23 is made of a magnetic material. The magnetic portion 23 is made of, for example, a metal material such as iron or steel. Each magnetic portion 23 has a curved surface 23a.

The curved surface 23a is a surface facing radially outward of the outer peripheral surfaces of the magnetic portion 23. When viewed from the axial direction, the curved surface 23a has a substantially arc shape protruding radially outward. That is, the outer peripheral surface of the magnetic portion 23 has a curved shape. As illustrated in FIG. 1, the curved surface 23a faces the stator 30 in the radial direction.

The shaft 24 has a substantially columnar shape that extends in the axial direction around the central axis J. The shaft 24 passes through the through hole 21c of the rotor core 21 in the axial direction. The shaft 24 is fixed to the inner peripheral surface of the through hole 21c. An upper portion of the shaft 24 is supported by the first bearing 15. A lower portion of the shaft 24 is supported by the second bearing 16. The shaft 24 is rotatably supported by the central axis J by the first bearing 15 and the second bearing 16. Accordingly, the rotor 20 is rotatable about the central axis J. The lower end of the shaft 24 protrudes to the outside of the housing 11 through the lower wall hole 12e.

The first bearing 15 rotatably supports an upper portion of the shaft 24. The second bearing 16 rotatably supports a lower portion of the shaft 24. In the present example embodiment, the first bearing 15 and the second bearing 16 are ball bearings. The first bearing 15 and the second bearing 16 may be rolling bearings other than ball bearings, or plain bearings.

The stator 30 is located radially outside the rotor 20. The stator 30 faces the rotor 20 in the radial direction with a gap interposed therebetween. The stator 30 is fixed to the inner peripheral surface of the side wall portion 12a. The stator 30 includes a stator core 31, an insulator 37, and a plurality of coils 38.

The stator core 31 has an annular shape extending in the axial direction around the central axis J. The stator core 31 faces the rotor 20 in the radial direction with a gap interposed therebetween. The stator core 31 has magnetism. For example, the stator core 31 is a laminated steel sheet formed by laminating a plurality of electromagnetic steel sheets in the axial direction. The axial dimension of the stator core 31 is larger than the axial dimension of the rotor 20. That is, the axial dimension of the stator core 31 is larger than the axial dimension of each of the rotor core 21, the magnet 22, and the magnetic portion 23. Therefore, according to the present example embodiment, as compared with the case where the axial dimension of the stator core 31 is smaller than or equal to the axial dimension of the rotor 20, the magnetic flux entering the stator core 31 from each of the upper edge portion of the rotor 20 and the lower edge portion of the rotor 20 is easily reduced. Therefore, when the rotor 20 rotates about the central axis J, the variation amount per unit time of the magnetic flux entering the stator core 31 from the rotor 20 is easily reduced, so that the cogging torque can be suppressed. The stator core 31 includes a core back portion 32 and a plurality of tooth portions 33.

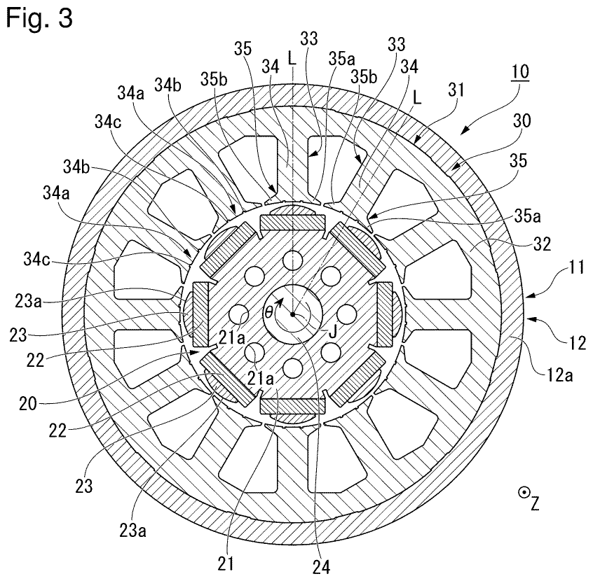

As illustrated in FIG. 3, the core back portion 32 has an annular shape centered on the central axis J. The outer peripheral surface of the core back portion 32 is fixed to the inner peripheral surface of the side wall portion 12a. Accordingly, the stator 30 is fixed to the housing 11.

Each of the plurality of tooth portions 33 extends radially inward from the core back portion 32. Each of the tooth portions 33 faces the rotor 20 with a gap in the radial direction. The tooth portions 33 are arranged at intervals along the inner peripheral surface of the core back portion 32. In the present example embodiment, the stator core 31 has twelve tooth portions 33. Each of the tooth portions 33 includes a tooth body portion 34 and an umbrella portion 35.

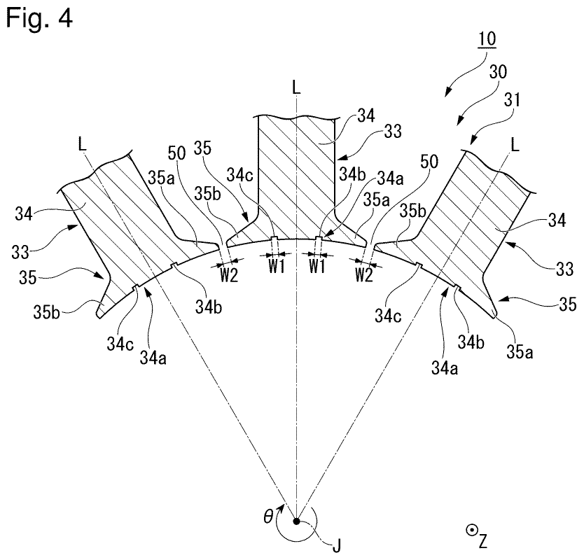

The tooth body portion 34 extends radially inward from the inner peripheral surface of the core back portion 32. The tooth body portion 34 has a substantially rectangular shape when viewed from the axial direction. As illustrated in FIG. 4, a surface of the tooth body portion 34 facing radially inward has an arc shape centered on the central axis J when viewed from the axial direction. As illustrated in FIG. 3, the surface of the tooth body portion 34 facing radially inward faces the rotor 20 with a gap in the radial direction. That is, the radially inner end of the tooth body portion 34 faces the rotor 20 with a gap in the radial direction. The tooth body portion 34 is provided with a groove portion 34a.

As illustrated in FIG. 4, the groove portion 34a is provided on a surface of the tooth body portion 34 facing radially inward. That is, the groove portion 34a is provided on a surface of the tooth portion 33 facing radially inward. The groove portion 34a extends along the axial direction. In the present example embodiment, the groove portion 34a extends from the upper end to the lower end of the surface of the tooth body portion 34 facing radially inward. In the present example embodiment, the groove portion 34a has a rectangular shape when viewed from the axial direction. Therefore, according to the present example embodiment, since the groove portion 34a has a rectangular shape which is a simple shape, the groove portion 34a can be easily configured by processing the plurality of electromagnetic steel sheets constituting the stator core 31 by a simple processing method such as press processing.

Therefore, it is possible to suppress an increase in the number of manufacturing steps and the manufacturing cost of the stator core 31 and the rotating electrical machine 10. The shape of the groove portion 34a is not limited to a rectangular shape, and may be other shapes such as a shape in which a semicircular groove is connected to the radially outer side of the rectangular groove, and a triangular shape. The groove portion 34a includes a first groove portion 34b and a second groove portion 34c.

The first groove portion 34b is provided in a portion on one circumferential direction side (+θ side) of a surface of the tooth body portion 34 facing the radial inside. The second groove portion 34c is provided in a portion on the other circumferential direction side (−θ side) of the surface of the tooth body portion 34 facing the radial inside. When viewed from the axial direction, the shape of the first groove portion 34b and the shape of the second groove portion 34c are the same. The dimension of the first groove portion 34b and the dimension of the second groove portion 34c in the circumferential direction are the same. In the following description, the dimension of the first groove portion 34b and the dimension of the second groove portion 34c in the circumferential direction are referred to as a groove width W1. The first groove portion 34b and the second groove portion 34c are provided at positions that are line-symmetric with each other with a reference line L passing through the center of the tooth portion 33 in the circumferential direction and the central axis J as an axis of symmetry.

The umbrella portion 35 protrudes to two sides in the circumferential direction from a radially inner portion of the tooth body portion 34, that is, a distal end portion of the tooth body portion 34. As a result, the circumferential dimension of the tooth portion 33 can be increased. Therefore, since the magnetic flux entering the tooth portion 33 from the rotor 20 can be increased in the circumferential direction, the rotational torque of the rotor 20 can be increased. The umbrella portion 35 includes a first umbrella portion 35a and a second umbrella portion 35b.

The first umbrella portion 35a protrudes to one circumferential direction side from a side surface facing one circumferential direction side (+θ side) of the distal end portion of the tooth body portion 34. When viewed from the axial direction, the first umbrella portion 35a has a substantially triangular shape protruding to one side in the circumferential direction. The surface of the first umbrella portion 35a facing radially inward has an arc shape centered on the central axis J. The radially inward surface of the umbrella first portion 35a is circumferentially connected to the radially inward surface of the tooth body portion 34.

The second umbrella portion 35b protrudes to the other circumferential direction side from a side surface facing the other circumferential direction side (−θ side) of the distal end portion of the tooth body portion 34. When viewed from the axial direction, the second umbrella portion 35b has a substantially triangular shape protruding to the other circumferential direction side. The radially inward surface of the second umbrella portion 35b has a substantially arc shape centered on the central axis J. The radially inward surface of the second umbrella portion 35b is circumferentially connected to the radially inward surface of the tooth body portion 34. The shape of the first umbrella portion 35a and the shape of the second umbrella portion 35b are line-symmetric with respect to each other with the reference line L as an axis of symmetry.

According to the present example embodiment, as described above, the groove portion 34a is provided on a surface of the tooth body portion 34 facing radially inward. Therefore, as compared with the case where the groove portion 34a is provided in the umbrella portion 35, the magnetic flux entering the tooth portion 33 from the rotor 20 is easily increased, and thus the magnetic force applied to the rotor 20 is easily increased. Therefore, the rotational torque of the rotor 20 can be increased.

The first umbrella portion 35a of one tooth portion 33 is disposed away from the second umbrella portion 35b of the other tooth portion 33 disposed adjacent to the tooth portion 33 on the one circumferential direction side (+0 side) in the circumferential direction via a gap portion 50. The gap portion 50 is a gap between the umbrella portions 35 of the tooth portions 33 adjacent to each other in the circumferential direction. A plurality of the gap portions 50 are provided at intervals along the circumferential direction. In the present example embodiment, twelve gap portions 50 are provided. Since the gap portion 50 is provided between the umbrella portions 35 of the respective tooth portions 33 adjacent to each other in the circumferential direction, it is possible to prevent the magnetic flux entering the tooth portions 33 from the rotor 20 from leaking out to the tooth portions 33 adjacent to each other in the circumferential direction via the umbrella portions 35 adjacent to each other in the circumferential direction. Therefore, it is possible to suppress an increase in variation in the circumferential direction of the magnetic force applied to the rotor 20 when the rotor 20 rotates about the central axis J. Therefore, the rotation of the rotor 20 about the central axis J can be stabilized.

When the gap portion 50 having a magnetic permeability smaller than that of the tooth portion 33 is provided between the tooth portions 33 adjacent to each other in the circumferential direction, the magnetic flux density entering each tooth portion 33 from the rotor 20 varies when the rotor 20 rotates. As a result, since the magnetic force applied to the rotor 20 fluctuates, the cogging torque that is pulsation of the motor torque is generated. The generation cycle of the cogging torque and the magnitude of the cogging torque are correlated with the number of poles of the rotor 20 and the number of gap portions 50. The number of times of generation of the cogging torque in the unit period in which the rotor 20 makes one rotation coincides with the least common multiple of the number of poles of the magnet 22 and the number of the gap portions 50. As described above, in the present example embodiment, the number of poles of the magnet 22 is eight, and the number of the gap portions 50 is twelve. Therefore, in the present example embodiment, the cogging torque is generated twenty four times in the unit period. The magnitude of the cogging torque decreases as the number of times of generation of the cogging torque in the unit period increases.

When the groove portion 34a is provided on the surface of the tooth portion 33 facing radially inward, the magnetic permeability of the portion of the tooth portion 33 where the groove portion 34a is provided is substantially reduced. Therefore, by providing the groove portion 34a, it is possible to increase the number of times the magnetic flux density entering each tooth portion 33 from the rotor 20 fluctuates when the rotor 20 rotates. As a result, the number of times of generation of the cogging torque can be increased in the unit period. In the present example embodiment, since each of the tooth portions 33 is provided with two grooves, that is, the first groove portion 34b and the second groove portion 34c, the number of times of generation of the cogging torque can be substantially the same as that in the case where thirty six gap portions 50 are provided. Therefore, since the number of times of generation of the cogging torque in the unit period can be increased to seventy two times, the cogging torque can be suppressed.

According to the present example embodiment, the stator 30 includes the stator core 31 radially opposing the rotor 20 with a gap interposed therebetween, and the stator core 31 includes the annular core back portion 32 centered on the central axis J and the plurality of tooth portions 33 arranged along the inner peripheral surface of the core back portion 32. The tooth portion 33 includes the tooth body portion 34 extending radially inward from the inner peripheral surface of the core back portion 32, and the umbrella portion 35 protruding to two sides in the circumferential direction at a distal end portion of the tooth body portion 34, and the groove portion 34a extending along the axial direction is provided on a surface facing radially inward of the tooth portion 33. Therefore, as described above, the magnetic permeability of the portion of the tooth portion 33 where the groove portion 34a is provided can be reduced. As a result, even in the groove portion 34a in addition to the gap portion 50, the magnetic flux density entering the tooth portion 33 from the rotor 20 varies when the rotor 20 rotates about the central axis J, and thus, it is possible to increase the number of times of generation of the cogging torque in the unit period. Therefore, the cogging torque generated when the rotor 20 rotates about the central axis J can be suppressed.

In addition, in the present example embodiment, the rotor 20 includes the shaft 24 extending in the axial direction about the central axis J, the rotor core 21 fixed to the shaft 24, the plurality of magnets 22 arranged in the circumferential direction on the radially outer surface of the rotor core 21, and the magnetic portions 23 respectively provided on the radially outer surfaces of the plurality of magnets 22, in each of which the outer peripheral surface, that is, the curved surface 23a is a curved surface. Therefore, when the rotor 20 rotates about the central axis J, the fluctuation in the gap between the tooth portions 33 and the rotor 20 can be made gentle, so that the fluctuation amount per unit time of the magnetic flux density entering each tooth portion 33 from the rotor 20 can be reduced. Therefore, since the variation amount per unit time of the magnetic force applied to the rotor 20 can be reduced, the torque ripple and the cogging torque of the rotating electrical machine 10 can be suppressed.

Furthermore, in the present example embodiment, as described above, since the magnetic portion 23 is made of, for example, a metal material such as iron or steel, the curved surface 23a of the magnetic portion 23 can be easily made by a simple working method such as press working. Therefore, it is possible to suppress an increase in the number of manufacturing steps of the rotor 20 and the rotating electrical machine 10 as compared with the case where the curved surface is formed on the outer peripheral surface of the magnet 22 where it is difficult to form the curved surface shape. In addition, as described above, since the magnetic portion 23 is made of a metal material such as iron or steel, for example, the shape accuracy of the curved surface of the outer surface of the magnetic portion 23 can be easily improved. Therefore, when the rotor 20 rotates about the central axis J, the amount of fluctuation per unit time of the magnetic flux density entering the tooth portion 33 from the rotor 20 can be more suitably reduced. Therefore, the torque ripple and the cogging torque of the rotating electrical machine 10 can be more suitably suppressed.

According to the present example embodiment, the radially outer surface of the magnetic portion 23, that is, the curved surface 23a, has an arc shape protruding radially outward when viewed from the axial direction. Therefore, when the rotor 20 rotates about the central axis J, the fluctuation in the magnetic flux density entering each tooth portion 33 from the rotor 20 can be curved. Therefore, when the rotor 20 rotates about the central axis J, the amount of fluctuation per unit time of the magnetic flux density entering each tooth portion 33 from the rotor 20 can be more suitably reduced. Therefore, the torque ripple and the cogging torque of the rotating electrical machine 10 can be more suitably suppressed.

According to the present example embodiment, the first groove portion 34b and the second groove portion 34c are arranged at positions symmetrical to each other with the reference line L passing through the center of the tooth portion 33 in the circumferential direction and the central axis J as an axis of symmetry. Therefore, the cogging torque can be suppressed in both the case where the rotor 20 rotates to one circumferential direction side (+0 side) and the case where it rotates to the other circumferential direction side (−θ side).

s illustrated in FIG. 4, in the present example embodiment, a groove width W1 is about 60% or more and 100% or less of a gap width W2 which is the circumferential dimension of the gap portion 50. In the present example embodiment, the groove width W1 is about 80% of the gap width W2. In the following description, the ratio of the groove width W1 to the gap width W2 is referred to as a groove width ratio W1/W2.

The insulator 37 insulates the stator core 31 from the coil 38. The insulator 37 has an insulating property. In the present example embodiment, the insulator 37 is made of resin.

As illustrated in FIG. 1, the insulator 37 is attached to each of the plurality of tooth portions 33. Each of the plurality of coils 38 is attached to the tooth portion 33 via the insulator 37. A current is supplied to each of the plurality of coils 38 from an external power supply (not illustrated).

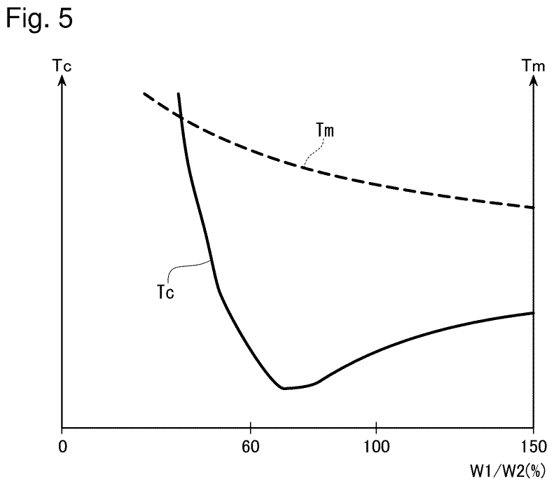

FIG. 5 is a diagram illustrating a relationship between the groove width ratio W1/W2, the cogging torque Tc, and the motor torque Tm in the rotating electrical machine 10 of the present example embodiment. The horizontal axis in FIG. 5 represents the groove width ratio W1/W2. The left vertical axis represents the cogging torque Tc. The right vertical axis represents the motor torque Tm.

As illustrated in FIG. 5, in a range where the groove width ratio W1/W2 is 70% or less, the cogging torque Tc rapidly decreases as the groove width ratio W1/W2 increases. When the groove width ratio W1/W2 is 70% or less, and the groove width ratio W1/W2 increases, the circumferential dimension of a portion of the tooth portion 33 where the magnetic permeability substantially decreases increases, so that the magnetic flux entering the tooth body portion 34 from the rotor 20 through the inner peripheral surface of the groove portion 34a can be reduced. As a result, since the number of times of generation of the cogging torque per unit period can be increased, the cogging torque Tc can be reduced. When the groove width ratio W1/W2 is in the range of 70% or more, the cogging torque Tc gradually increases as the groove width ratio W1/W2 increases. This is presumed to be because as the groove width W1 of the groove portion 34a increases, the magnetic flux entering the tooth portion 33 from the inner peripheral surface of the groove increases, so that the substantial permeability of the tooth portion 33 in the portion where the groove portion 34a is provided gradually increases. As a result, by providing the groove portion 34a having the groove width ratio W1/W2 of 60% or more and 100% or less as compared with the case where the groove portion 34a is not provided in the tooth portion 33, that is, the case where the groove width ratio W1/W2 is 0%, the cogging torque Tc can be suitably suppressed. In addition, as described above, in the present example embodiment, since the groove width ratio W1/W2 is 80%, the cogging torque Tc can be suitably suppressed.

The motor torque Tm gradually decreases as the groove width ratio W1/W2 increases. This is because when the groove width W1 increases, the average distance between the surface of the tooth body portion 34 facing the radial inside and the rotor 20 increases. However, since the amount of decrease in the motor torque Tm with respect to the groove width ratio W1/W2 is small, it is possible to suppress a large decrease in the motor torque Tm by providing the groove portion 34a in the tooth portion 33. Therefore, according to the present example embodiment, by setting the groove width ratio W1/W2 to 60% or more and 100% or less, it is possible to suppress a large decrease in the motor torque Tm while suppressing the cogging torque Tc.

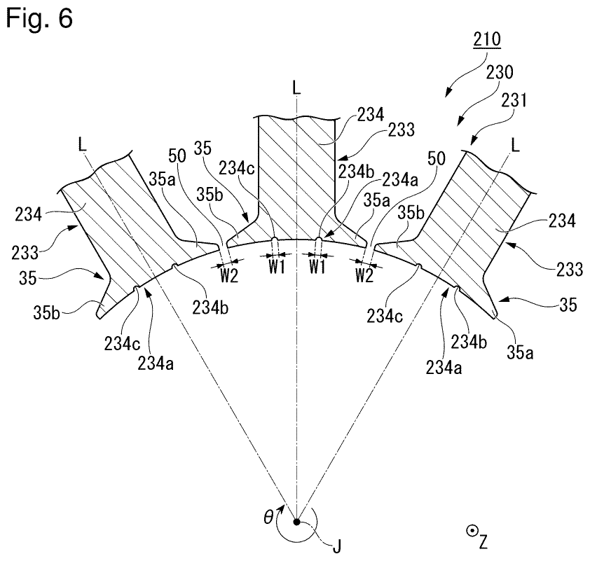

FIG. 6 is a cross-sectional view illustrating a part of a stator core 231 included in a stator 230 according to a modification of the present example embodiment. In the following description, the same reference numerals are given to constituent elements of the same aspects as those of the above-described example embodiment, and the description thereof will be omitted.

As illustrated in FIG. 6, a groove portion 234a is provided on a surface of a tooth body portion 234 facing radially inward of a tooth portion 233 of the present modification. In the present modification, the groove portion 234a has a semicircular shape when viewed from the axial direction. Therefore, according to the present modification, since the groove portion 234a has a semicircular shape which is a simple shape, the groove portion 234a can be easily configured by processing the plurality of electromagnetic steel sheets constituting the stator core 231 by a simple processing method such as press processing. Therefore, it is possible to suppress an increase in the number of manufacturing steps and the manufacturing cost of the stator core 231 and the rotating electrical machine 210. The groove portion 234a includes a first groove portion 234b and a second groove portion 234c.

The first groove portion 234b is provided in a portion on one circumferential direction side (+θ side) of a surface of the tooth body portion 234 facing the radial inside. The second groove portion 234c is provided in a portion on the other circumferential direction side (−θ side) of the surface of the tooth body portion 234 facing the radial inside. When viewed from the axial direction, the shape of the first groove portion 234b and the shape of the second groove portion 234c are the same. The first groove portion 234b and the second groove portion 234c are provided at positions that are line-symmetric with each other with the reference line L as an axis of symmetry.

In the present modification, a groove width W1 is set to 60% or more and 100% or less of a gap width W2 which is a circumferential dimension of portion 50 in the a gap circumferential direction. In the present modification, the groove width W1 is about 80% of the gap width W2. The other configurations of the stator 230 of the present modification are similar to the other configurations of the stator 30 of the above-described example embodiment.

The relationship among the groove width ratio W1/W2, the cogging torque Tc, and the motor torque Tm in the rotating electrical machine 210 of the present modification is similar to the relationship among the groove width ratio W1/W2, the cogging torque Tc, and the motor torque Tm of the present example embodiment illustrated in FIG. 5. Therefore, in the present modification, as in the above-described example embodiment, by setting the groove width ratio W1/W2 to 60% or more and 100% or less, it is possible to suppress the motor torque Tm from greatly decreasing while suitably suppressing the cogging torque Tc.

Furthermore, in the present modification, the groove portion 234a is provided on a surface of the tooth portion 233 facing radially inward. Therefore, similarly to the present example embodiment described above, since the magnetic permeability of the portion of the tooth portion 233 where the groove portion 234a is provided can be reduced, the number of times of generation of the cogging torque per unit period can be increased. Therefore, the cogging torque Tc generated when the rotor 20 rotates about the central axis J can be suppressed.

The present disclosure is not limited to the above-described example embodiment, and other configurations and other methods can be employed within the scope of the technical idea of the present disclosure. For example, the number of tooth portions included in the stator core is not limited to twelve, and may be eleven or less or thirteen or more. In addition, the stator core may be a stator core that is disposed on the radially inner side of the rotor and is used for a rotating electrical machine having an outer rotor configuration in which the tooth portion protrudes radially outward.

Each of the number of magnets and the number of magnetic portions included in the rotor is not limited to eight, and may be seven or less or nine or more.

The shape of the umbrella portion is not limited to that in the present example embodiment, and may be, for example, another shape such as a substantially rectangular shape protruding in the circumferential direction when viewed from the axial direction. Further, the umbrella portion may not be provided.

The configuration of the groove portion is not limited to that in the present example embodiment, and for example, the number of groove portions provided in each tooth portion may be one or three or more. The number of groove portions provided in each tooth portion may be different from each other. However, the groove portions are preferably arranged line-symmetrically with respect to the reference line as a symmetry axis, and when an odd number of grooves are provided, one groove is preferably arranged at a position overlapping the reference line.

A rotating electrical machine to which the present disclosure is applied is not limited to a motor, and may be a generator. The application of the rotating electrical machine to which the present disclosure is applied is not particularly limited. The rotating electrical machine may be mounted on a vehicle for uses other than the use of rotating an axle for example, or may be mounted on equipment other than a vehicle.

The structures described above in the present description may be appropriately combined in a range where no conflict arises.

Note that the present technique can have a configuration as described below.

(1) A rotating electrical machine comprising: a rotor rotatable about a central axis; and a stator located radially outside the rotor; wherein the rotor includes: a shaft extending in an axial direction about the central axis; and a rotor core fixed to the shaft; a plurality of magnets arranged in a circumferential direction on a radially outer surface of the rotor core; and a magnetic portion provided on a radially outer surface of each of the plurality of magnets and including an outer peripheral surface that is a curved surface, the stator includes a stator core radially opposing the rotor with a gap, the stator core includes a core back portion having an annular shape centered on the central axis, and a plurality of tooth portions arranged along an inner peripheral surface of the core back portion, each of the plurality of tooth portions includes a tooth body portion extending radially inward from an inner peripheral surface of the core back portion, and an umbrella portion protruding to two sides in a circumferential direction at a distal end portion of the tooth body portion, and a groove portion extending along the axial direction is provided on a surface of each of the plurality of tooth portions facing radially inward.

(2) The rotating electrical machine according to (1), wherein the groove portion is provided on a surface facing radially inward of the tooth body portion.

(3) The rotating electrical machine according to (1) or (2), wherein a radially outer surface of the magnetic portion has an arc shape protruding radially outward when viewed from the axial direction.

(4) The rotating electrical machine according to any one of (1) to (3), wherein the groove portion includes a first groove portion and a second groove portion, and the first groove portion and the second groove portion are arranged at positions symmetrical to each other with a reference line passing through a center of each of the plurality of tooth portions in the circumferential direction and the central axis as an axis of symmetry.

(5) The rotating electrical machine according to any one of (1) to (4), wherein a dimension of the groove portion in the circumferential direction is about 60% or more and 100% or less of a dimension of a gap between the umbrella portions provided to the plurality of tooth portions adjacent to each other in the circumferential direction.

(6) The rotating electrical machine according to any one of (1) to (5), wherein the groove portion has a semicircular shape when viewed from the axial direction.

(7) The rotating electrical machine according to any one of (1) to (5), wherein the groove portion has a rectangular shape when viewed from the axial direction.

(8) The rotating electrical machine according to any one of (1) to (7), wherein an axial dimension of the stator core is larger than an axial dimension of the rotor core.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A rotating electrical machine comprising:
a rotor rotatable about a central axis; and
a stator located radially outside the rotor; wherein
the rotor includes:
a shaft extending in an axial direction about the central axis; and
a rotor core fixed to the shaft;
a plurality of magnets arranged in a circumferential direction on a radially outer surface of the rotor core; and
a magnetic portion provided on a radially outer surface of each of the plurality of magnets and including an outer peripheral surface in a curved shape;
the stator includes a stator core radially opposing the rotor with a gap;
the stator core includes a core back portion having an annular shape centered on the central axis, and a plurality of tooth portions arranged along an inner peripheral surface of the core back portion;
each of the plurality of tooth portions includes a tooth body portion extending radially inward from an inner peripheral surface of the core back portion, and an umbrella portion protruding to two sides in a circumferential direction at a distal end portion of the tooth body portion; and
a groove portion extending along the axial direction is provided on a surface facing radially inward of each of the plurality of tooth portions.

2. The rotating electrical machine according to claim 1, wherein the groove portion is provided on a surface facing radially inward of the tooth body portion.

3. The rotating electrical machine according to claim 2, wherein the outer peripheral surface of the magnetic portion has an arc shape protruding radially outward when viewed from the axial direction.

4. The rotating electrical machine according to claim 3, wherein
the groove portion includes a first groove portion and a second groove portion; and
the first groove portion and the second groove portion are arranged at positions symmetrical to each other with a reference line passing through a center of each of the plurality of tooth portions in the circumferential direction and the central axis as an axis of symmetry.

5. The rotating electrical machine according to claim 3, wherein a dimension of the groove portion in the circumferential direction is 60% or more and 100% or less of a dimension of a gap between the umbrella portions provided to the plurality of tooth portions adjacent to each other in the circumferential direction.

6. The rotating electrical machine according to claim 5, wherein the groove portion has a rectangular or substantially rectangular shape when viewed from the axial direction.

7. The rotating electrical machine according to claim 5, wherein the groove portion has a semicircular or substantially semicircular shape when viewed from the axial direction.

8. The rotating electrical machine according to claim 3, wherein an axial dimension of the stator core is larger than an axial dimension of the rotor core.
